(19) United States
(12) Patent Application Publication
(10) Pub. No.: US 2026/0237888 A1
(43) Pub. Date: Aug. 13, 2026

(54) ANTENNA MODULE FOR A RECEIVER FOR MOBILE RECEPTION OF SIGNALS OF A GLOBAL POSITIONING SATELLITE

(71) Applicant: FUBA Automotive Electronics GmbH, Bad Salzdetfurth (DE)

(72) Inventors: Stefan LINDENMEIER, Gauting (DE); Heinz LINDENMEIER, Planegg (DE)

(21) Appl. No.: 18/729,120

(22) PCT Filed: Jan. 18, 2023
(86) PCT No.: PCT/EP2023/051127

§ 371 Date: Feb. 10, 2026

(30) Foreign Application Priority Data
Jan. 19, 2022 (DE) 102022000191.8

(51) Int. Cl. H01Q 1/32; H01Q 9/04; H01Q 9/16; H01Q 9/30; H01Q 21/06

(52) U.S. Cl. CPC H01Q 1/3233; H01Q 9/0428; H01Q 9/16; H01Q 9/30; H01Q 21/06

(57) ABSTRACT

An antenna module for a receiver for mobile reception of locating satellite signals having a radio frequency input is disclosed, said antenna module comprising an electrically conductive base surface and an antenna module terminal for connecting a receiver, wherein the antenna module includes an antenna diversity function.

The invention relates to an antenna module 1 for a receiver 2 for mobile reception of locating satellite signals having a radio frequency input 41 and an optional DCout terminal 12 for supplying power to peripheral devices, said antenna module 1 comprising an in particular substantially horizontally oriented electrically conductive base surface 6 and an optional antenna module terminal 4 for connecting the receiver 2.

In particular with satellite navigation systems, the profitability and, with respect to the transmission power irradiated by the satellite, the efficiency of the reception antenna are particularly important. Satellite radio signals are usually transmitted using circularly polarized electromagnetic waves due to polarization rotations on the transmission path and are used for all known satellite navigation systems. Modern navigation systems provide for an evaluation of the simultaneously received radio signals of a plurality of satellite navigation systems, in particular for global availability in conjunction with a high navigation accuracy in mobile navigation. Such systems that receive in combination are subsumed under the term GNSS (global navigation satellite system) and include known systems such as GPS, GLONASS, Galileo and Beidou, etc. Satellite antennas for navigation on vehicles are usually set up on the electrically conductive outer skin of the vehicle body. Circularly polarized satellite reception antennas are used such as are known from the documents DE102009040910.6, DE-A-4008505, and DE-A-10163793. In particular those antennas that are characterized by a low construction height in conjunction with a cost-effective manufacturing capability are suitable for the setup on vehicles. This includes, for example, the circular, polygonal or quadratic ring line antenna 17, 20 designed as a resonant structure known from the document DE102009040910.6 that has a small construction volume and that is in particular an absolute requirement for mobile applications. The antenna has a necessary conductive base surface 6 of a comparatively small size and is very low with a height of less than one tenth of the free-space wavelength. Patch antennas 24 that are, however, less powerful with respect to reception at a low elevation angle are known according to the prior art as further antennas for satellite navigation on vehicles.

Antennas for receiving navigation satellite signals are right-handed circularly polarized, RHCP, to match the signals transmitted by the satellites. Normally, the antenna is connected via a radio frequency line to the radio frequency input 41 of a receiver 2 for mobile reception of locating satellite signals. In mobile reception, the levels of the reception signals of individual satellites are well below the level of the stochastic noise so that the evaluation of the reception signals can take place solely using correlation technologies. A plurality of coordinators is therefore present in the receiver, wherein each correlator is associated with a locating satellite. If the signal of a satellite is recognized in the noisy signal via a correlator, this signal can be tracked very reliably during the movement of the vehicle, i.e. a considerable interference of the radiation path is required to lose the signal.

The recognition of the individual digitally modulated satellite signals 1, 2, 3, . . . in the noisy reception signal takes place in that the autocorrelation maximum has to be found by synchronization with the respective associated correlator. This means that the code signal C1, C2, C3 associated with each satellite is correlated with the reception signal by realizing a respective variable time delay t1, t2, t3, . . . in one run-through between the code signals and the reception signal until there is in each case synchronicity between the satellite code received in the reception signal and the code signal C1, C2, C3 generated in the receiver. In this respect, a maximum and the ideal time delays t1=t1opt, t2=t2opt, t3=t3opt, . . . necessary for this purpose are produced in the respective correlation function ct1, ct2, ct3 . . . Once the signals have been found, a localization by triangulation can be performed on this basis if at least four signals have been detected. The fourth signal is necessary for defining a common time base since the point in time of the transmission of the signals to the satellite is otherwise not known exactly to the receiver and the three coordinates x, y, z of the receiver thus could not be deduced from the time delays t1opt, t2opt, t3opt corresponding to the arrival times.

At least four signals of the plurality of satellite signals must thus be receivable such that they can be synchronized by correlation to enable a location determination.

To locate the satellite signals, an antenna signal that is as strong as possible is necessary so that the satellites can be found quickly. A major problem with the satellite radio connection is therefore the system startup or after a signal has been lost for a long time, which must therefore be searched for again via a startup and identified via the correlation.

In particular in urban, wooded or mountainous areas, the line of sight between the vehicle and a plurality of satellites is often not available so that a drastic reduction in the reception signal strength for their signals takes place due to shadows and the startup of the system takes a long time or, in extreme cases, is not possible at a location. After the startup, the satellite signals can be tracked by tracking the above-described time delays from the located optimum values. A longer integration time per time delay can be selected for this purpose since not all possible time delays have to be run through. Therefore, a significantly smaller reception signal is now sufficient for the localization.

It is therefore the underlying object of the invention to provide an antenna module for a receiver for mobile reception of locating satellite signals that enables the startup of the locating system or reduces it in time in the event of a partly interrupted line of sight between the vehicle and a plurality of satellites, i.e. in particular in urban or wooded or mountainous areas.

This object is satisfied by the features of claim 1.

An antenna module 1 for a receiver 2 for mobile reception of locating satellite signals having a radio frequency input is disclosed comprising an in particular substantially horizontally oriented electrically conductive base surface 6 and an antenna module terminal 4 for connecting a radio frequency line 40 as a connection to the radio frequency terminal 41 of a receiver 2, characterized by one or more of the following features by which the antenna module 1 includes an antenna diversity function:
On the electrically conductive base surface 6, a multi-antenna system 3 is formed from a plurality of mutually concentrically arranged individual antennas 3a, 3b, 3c . . . for receiving respective separate locating satellite signals 5a, 5b, 5c, in each case with an azimuthal omnidirectional diagram of the radiation density and an azimuthally linear distribution of the phase angle Ø=0-2π*N of an integer Nth order of the radiation over a corresponding azimuthal angle range of α=0-2π, comprising an N=1-th order circularly polarized first reception antenna 3a for receiving locating satellite signals with the main radiation direction towards the zenith,
   and
at least one further individual antenna 3b, 3c . . . whose order N differs from the order of the first reception antenna 3a by the integer 1 in each case.
In the antenna module 1, a reception signal combiner is present which is controlled according to a permanently installed sequence program, which has an output-side connection to the antenna module terminal 4 and to which the separate reception signals 5a, 5b, 5c of the individual antennas 3a, 3b, 3c . . . are fed at the input side, of which reception signals 5 a, 5 b, 5c—in a sequence repeating cyclically according to one period t0 of the time duration t0 over one reception interval t1 of the time duration t1—the reception signal 5a of the first reception antenna 3a and additively superposed thereon, over at least one search interval t2 of the time duration t2, a reception signal 5b, 5c of one of the further individual antennas 3b, 3c, which is clocked in steps in its phase and is shifted—at least once—between the phase angle range β=0 to β=2π, are thus present as a linearly combined receiver signal 9 at the antenna module terminal 4 so that, during the search interval t2, a radiation directional diagram with azimuthally between α=0 to α=2π—i.e. at least once—is given over a full rotation of the main direction pivoted in steps.
The period t0 and its division into the reception interval t1 and the search interval t2 as well as the number of rotations of the main direction are mutually coordinated and fixedly set such that the synchronization time is statistically as short as possible for as many received satellite signals as possible.
In the antenna module 1, there is a DCin terminal 13 with whose connection to an external DC power supply via a 0terminal 12 the sequence program of the reception signal combiner (7) is started.

The reception signal combiner 7 can comprise a combination circuit 8, which is switched in a controlled manner and to which the separate reception signals 5a, 5b, 5c of the individual antennas 3a, 3b, 3c . . . are fed, for the controlled selection of the first reception signal 5a during the reception interval t1 as a receiver signal 9

and/or the additive superposition, formed during the search interval t2, of said reception signal 5a with the reception signal 5b, 5c of one of the further individual antennas 3b, 3c, which is rotated in phase in a controlled stepwise manner, as a linearly combined receiver signal 9 can in each case be formed at the antenna module terminal 4.

The reception signal combiner 7 can further comprise a control logic circuit 10 programmed by the sequence for setting various switching states of the switchable combination circuit 8 and an independently operating clock generator 11 for generating a cyclically repeating clock sequence with the period to, in each case consecutively divided into cycles with a time interval t1 and cycles with a time interval t2 for the clocked control of the programmed control logic circuit 10.

The combination circuit 8 switched in a controlled manner can comprise the signal path 15a of the reception signal 5a of the first individual antenna 3a with a summation element 16 for superposing this reception signal with the reception signals from the signal path 15b of the further reception antenna 3b to form the receiver signal 9 at the antenna module terminal 4.

The combination circuit 8 switched in a controlled manner can further comprise the signal path 15b of the further reception signal 5b, 5c of one of the further reception antennas 3b, 3c with a phase rotation element 23, which is controlled in phase steps between β=0 to β=2π by the control logic circuit 10 during the search interval t2, and a switch 14, which is open by control during the reception interval t1 and closed during the search interval t2, for the controlled forwarding of the further reception signal 5b, 5c rotated in phase to the summation element 16 in order to form the receiver signal 9 by superposition with the first reception signal.

The combination circuit 8 switched in a controlled manner may further include control lines between the programmed control logic circuit 10 and the controlled phase rotation element 23 for the clocked setting of the phase rotation element 23 during the search interval t2 and the switch 14 for controlling its opening during the reception interval t1 and its closing during the search interval t2.
In the combination circuit 8, a summation element 16 can be present in the signal path 15a of the fed first reception signal 5a, in which summation element 16, by the switch 14 controlled by the control logic circuit 10, the reception signals 5a, 5b occurring after the switch are superposed during the search interval t2.
A phase rotation element 23 controlled in phase steps by the control logic circuit 10 and, in series therewith, a switch 14 controlled by the control logic circuit 10 are inserted in the signal path 15b of the second reception signal 5b for the controlled switching through of the reception signal 5b to the summation element 16.
The control logic circuit 10 can be programmed such that the switch 14 is opened during the reception interval t1 and closed during the search interval t2 so that, alternately, in each case during the reception interval t1, the effect of a right-handed circularly polarized, RHCP, antenna with the main radiation direction facing towards the zenith is given at the antenna module terminal 4 and, during the search interval t2, by the superposition with the second reception signal 5b that is changed in steps in the phase in the settable phase rotation element 23, after the superposition in the summation element 16, an antenna with azimuthally bundled radiation with the main radiation direction azimuthally pivoted in steps can be given at the antenna module terminal 4.
The multi-antenna system 3 can comprise, as the first individual antenna 3a, an N=1-th order ring line antenna 17, with right-handed circular polarization, RHCP, and the main radiation direction towards the zenith, that can be formed as a ring line 18 arranged above the electrically conductive base surface 6 with the current distribution of a running line wave in a single revolving direction whose phase difference over one revolution is just 2π and that can be designed with four vertical radiators 19a, 19b, 19c, 19d connected to the ring line 18 and offset azimuthally by 90 degrees from one another, with tapping of the first reception signal 5a at a first of the vertical radiators 19a for forwarding to the reception signal combiner 7.
The multi-antenna system 3 can comprise, as the second individual antenna 3b, an N=0-th order vertical monopole antenna 34—for receiving the second reception signal 5b and for its forwarding to the reception signal combiner 7—that is arranged concentrically to the N=1-th order ring line antenna 17.
However, instead of the N=1-th order ring line antenna 17 arranged at the center, the multi-antenna system 3 can include an N=1-th order patch antenna 24, with right-handed circular polarization (RHCP) and a distribution of the phase angle of the radiation of β=0-2π over the azimuthal solid angle α=0-2π and the main radiation direction towards the zenith, as the first reception signal 5a and the concentrically arranged N=0-th order vertical monopole antenna 34 for receiving the second reception signal 5b can be centrally arranged at a low height above the patch antenna 24.

The multi-antenna system 3 can comprise, as the first individual antenna 3a, an N=1-th order ring line antenna 17 with right-handed circular polarization, RHCP, and the main radiation direction towards the zenith, which can be designed as a ring line 18 arranged above the electrically conductive base surface 6, with the current distribution of a running line wave in a single revolving direction whose phase difference over one revolution is just 2π. There can be four vertical radiators 19a, 19b, 19c, 19d connected to the ring line and offset azimuthally by 90 degrees from one another and the tapping of the separate first reception signal 5a can be designed at a first of the vertical radiators 19a for forwarding to the reception signal combiner 7.
The multi-antenna system 3 can comprise, as the second individual antenna 3b, a 2nd order ring line antenna 20 with right-handed circular polarization, RHCP, and the main radiation direction towards the zenith that can be designed as an N=2-th order ring line 18 arranged above the electrically conductive base surface 6 with the current distribution of a running line wave in a single revolving direction whose phase difference over one revolution is just 4π. There can be eight further vertical radiators 22a, . . . 22h connected to the ring line and offset azimuthally by 45 degrees from one another, with tapping of the second reception signal 5b at a first of the vertical radiators 22a for forwarding to the reception signal combiner 7.

Instead of the N=1-th order ring line antenna 17 as the first individual antenna 3a at the center of the second individual antenna 3b, an N=1-th order patch antenna 24 can be present, with right-handed circular polarization (RHCP) and a distribution of the phase angle of the radiation of β=0-2π over the azimuthal solid angle α=0-2π and the main radiation direction towards the zenith, as the first reception signal 5a for forwarding to the reception signal combiner 7.

Instead of the N=1-th order ring line antenna 17 as the first individual antenna 3a with the first reception signal 5a at the center of the second reception antenna 3b, a crossed dipole antenna 26 with right-handed circular polarization, RHCP, and the main radiation direction towards the zenith can be present. Said crossed dipole antenna 26 can consist of two dipoles that are located on a mast arranged vertically above the conductive base surface 6, that are crossed by 90 degrees, that are substantially horizontally oriented and whose dipole halves open downwardly in a V shape and whose reception signals are combined via a 90 degree phase rotation element 25 to form the first separate reception signal 5a—for forwarding to the reception signal combiner 7.

The multi-antenna system 3 can comprise, as the first individual antenna 3a, an N=1-th order ring line antenna 17 with right-handed circular polarization, RHCP, and the main radiation direction towards the zenith. Said ring line antenna 17 can be formed by a ring line 18 arranged above the electrically conductive base surface 6 with the current distribution of a running line wave in a single revolving direction whose phase difference over one revolution is just 2π. The ring line 18 can be connected to four vertical radiators 19a, . . . 19d offset azimuthally by 90 degrees from one another, wherein the tapping of the first reception signal 5a at a first of the vertical radiators 19a can be given for forwarding the reception signals 5a to the reception signal combiner 7.

The second individual antenna 3b of the multi-antenna system 3 can be formed as an N=0-th order combined loop monopole antenna 27 with circularly polarized, azimuthally in-phase radiation such that a loop antenna 35 is designed from a conductor loop 31 with capacitors 36—concentric to the ring line antenna 17—and can consist of a conductor loop 31 arranged substantially in a horizontal plane in parallel above the conductive base surface 6 with a current distribution uniform in phase and amplitude. The reception signal present at an interruption as a conductor loop connection point 37 of the conductor loop 31 can be combined via a 90 degree phase rotation element 25 with the reception signal of an N=0-th order vertical antenna 34 arranged at the center of the conductor loop 31 to form the reception signal 5b with a likewise N=0-th order for right-handed circular polarization, RHCP, in the summation element 16 for forming the main radiation direction in the central region of the elevation—for forwarding the reception signals 5b to the reception signal combiner 7.

The multi-antenna system 3 can comprise, as an N=1-th order first reception antenna 3a, a crossed dipole antenna 26 with right-handed circular polarization, RHCP, and the main radiation direction towards the zenith, consisting of two dipoles that are located on a mast 28 arranged vertically above the conductive base surface 6, that are crossed by 90 degrees, that are substantially horizontally oriented and whose dipole halves open downwardly in a V shape and whose reception signals are combined via a 90 degree phase rotation element 25 to form the first separate reception signal 5a for forwarding to the reception signal combiner 7.

The multi-antenna system 3 can comprise, as an N=0-th order second reception antenna 3b, a vertical monopole antenna 34 located on the mast 28 for forwarding its reception signal 3b to the reception signal combiner 7.

Instead of the summation element 16 and the switch 14, a radio frequency diplexer 38 can be used which is set in the signal transmission V1, V2 by the control logic circuit 10 and in which the first reception signal 5a is assessed with the factor V1 and the second reception signal 5b′ occurring after the settable phase rotation element 23 is assessed with the factor V2 and both reception signals 5a, 5b′ are superposed to form the combined receiver signal 9.

The control logic circuit 10 can be programmed in an extended manner such that V1=1 is set and the setting of the signal transmission V2 of the radio frequency diplexer is also set, starting with the setting V2=1, with values decreasing in V2 steps. For each V2 step, the phase of the settable phase rotation element 23 can pass through the phase range, starting from 0° to 360°, in phase steps so that in each case a full azimuthal rotation of the main radiation direction is given and the radiation diagram with an azimuthal main direction with decreasing signal transmission values V2 in steps up to V2=0 can be converted into an azimuthal omnidirectional diagram with the main direction towards the zenith.

In one embodiment, the control logic circuit 10 is programmed in an extended manner such that V1=1 and V2=0 is set so that the azimuthal omnidirectional diagram present for the normal reception is set and such that, at the start of the cycle, the phase of the settable phase rotation element 23 passes through the phase range, starting from 0° to 360°, in phase steps after the start of the cycle so that in each case a full azimuthal rotation of the main radiation direction is given and, during this phase rotation (or fewer phase rotations), the directional diagram is converted into the radiation diagram with the azimuthal main direction by signal transmission values V2 continuously increasing in small steps up to a maximum value (e.g. V2=0.2) so that in each case a full azimuthal rotation of the main radiation direction is given, and such that the setting of the maximum value of V2 is (optionally) maintained for a few rotations, and such that, in order to end the cycle, the setting of the signal transmission V2 of the radio frequency diplexer is set, starting with its maximum value, in continuously decreasing values, and such that the radiation diagram with the azimuthal main direction is converted back into the radiation diagram with an azimuthal omnidirectional diagram with the main direction towards the zenith in the time during which the phase of the settable phase rotation element 23 continued to pass through the phase range, starting from 0° to 360°, in phase steps, from the maximum value of V2 up to the value V2=0. In this respect, the radio frequency diplexer can alternatively also be built up by a variable damping member in series with the phase rotation element and by a power combiner or by similar components.

The multi-antenna system 3 can additionally have, as a third individual antenna 3c, an N=0-th order vertical monopole antenna 34, which is concentrically arranged at the center of the N=1-th order ring line antenna 17, for receiving the third reception signal 5c and the self-controlled signal combiner 7 can comprise one or more of the following features.

A changeover switch 39 controlled by the control logic circuit 10 can be connected upstream of the settable phase rotation element 23, to which changeover switch 39 the second reception signal 5b and the third reception signal 5c are fed for an alternatively switched forwarding to the settable phase rotation element 23.

The programming of the control logic circuit 10 can be supplemented and the changeover switch 39 can be controlled accordingly by the control logic circuit 10 such that the search interval t2 is divided into the search interval t2a, during which the second reception signal 5b is switched through to the phase rotation element 23, and into the search interval t2b, during which the third reception signal 5c is switched through to the phase rotation element 23, and the phase rotation element 23 is controlled in phase steps in each case over the range β=0 to β=2π during the search interval t2a and the search interval t2b and the switch 14 is closed during the two search intervals t2a and t2b.

Instead of the summation element 16 and the switch 14, a radio frequency diplexer 38 can be used which is set in the signal transmission V1, V2 by the control logic circuit 10 and in which the first reception signal 5a can be assessed with the factor V1 and the second reception signal 5b′ occurring after the settable phase rotation element 23 during the search interval t2a can be assessed with the factor V2 and the third reception signal 5c′ occurring during the search interval tb2 can be assessed with the factor V2b and in each case both reception signals 5a, 5b′ or 5a, 5c′ can be superposed to form the combined receiver signal 9.

The control logic circuit 10 can be programmed in an extended manner such that V1=1 is set and the setting of the signal transmission V2a or V2b of the radio frequency diplexer is set, approximately starting with the setting V2a=V2b=1, with values decreasing in steps and, for each step, the phase of the settable phase rotation element 23 can have passed through the phase range, starting from 0° to 360°, in phase steps at least once so that, for both positions of the changeover switch 39, in each case at least one full azimuthal rotation of the main radiation direction is given and the radiation diagram with the azimuthal main direction with decreasing signal transmission values V2a or V 2b in steps up to V2a=0 or V2b=0 is converted in each case into an azimuthal omnidirectional diagram with the main direction towards the zenith.

In the self-controlled signal combiner 7, a sequence program can be stored that is designed such that, with its start (t=0), before the onset of the time sequences of the period t0, a startup interval tA of the temporal length tA takes place during which the switch 14 is closed. In consecutive temporal step lengths ta, the settable phase rotation element 23 can be set accordingly changed in each case so that the horizontal radiation diagram is rotated further with its main direction in the azimuth by one angular step, whereby the radiation directional diagram is rotated with its main direction once in each case during the rotation time tu and at least z=1 time during the startup interval tA—over a full horizontal rotation. The following particular advantages, among others, result by means of the reception system according to the invention:

The antenna module 1 with a self-controlled antenna diversity function for a series-produced receiver 2 for mobile reception of locating satellite signals with a radio frequency input 41 can be connected solely via the latter to the receiver. A further connection to the receiver 2 is not necessary.

This antenna diversity arrangement is characterized by its particular cost-effectiveness.

The DC power supply of the antenna module 1 can take place without effort via the vehicle electrical system or, if it is present, via a DCout terminal 12 at the receiver 2.

The design of the antenna module 1 consisting of in each case different antenna structures that can be combined in a small space and that are drawn in one another, such as a first-order circularly polarized ring antenna combined with a 0th order linear antenna, a 1st order ring line antenna combined with a 2nd order ring antenna, and a combination of a ring antenna with a rod monopole to form a ring monopole antenna, etc., enables the desired antenna diversity function with a particularly small space requirement on the vehicle surface.

A multi-antenna system 3 for an antenna module 1 according to the invention can advantageously be formed from a plurality of individual antennas 3a, 3b, 3c, . . . , in each case with a mutually different polarization and/or main direction for receiving locating satellite signals, in each case with separate reception signals 5a, 5b, 5c. Such individual antennas 3a, 3b, 3c . . . are often based on circularly polarized satellite reception antennas according to the prior art, such as are known from the documents DE102009040910.6, DE-A-4008505, and A-10163793. These antennas are particularly suitable for the setup on vehicles since they are characterized by a low construction height and a small base surface requirement in conjunction with a cost-effective manufacturing capability. They in particular also include—for example—the circular, polygon-shaped or square ring line antennas designed as resonant structures known from the document DE102009040910.6 that have a small construction volume, or patch antennas, etc.

A diversity reception system for a satellite reception system for satellite radio reception is known from DE 10206385. There, the antenna arrangement forms a separate unit from the receiver to produce the diversity function. There, the check of the reception level and the switchover of the antennas take place in synchronization with the symbol clock of the data signals. For this purpose, both symbol clock signals and the reception level signals from the receiver are fed to the antenna arrangement to create the diversity function.

The self-controlled diversity reception system according to the present invention operates autonomously from the receiver in an economically advantageous manner. The supply of the clock signals and reception level signals generated in the receiver does not have to be provided.

The invention will be described in more detail below with reference to the figures:

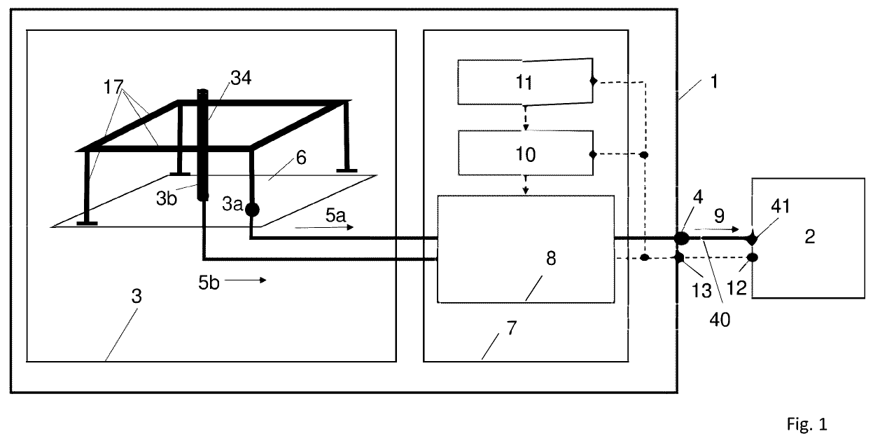

FIG. 1: Shows the basic structure of an antenna module 1 according to the invention with the individual antennas 3a, 3b as a multi-antenna system 3 and a self-controlled signal combiner 7 that is connected thereto and that comprises the controllable and switchable combination circuit 8 for the controlled selection and controlled formation of linear combinations from the selected reception signals 5a, 5b to form the combined receiver signal 9 and for its forwarding via the antenna module terminal 4 and the radio frequency line 40 to the RF input terminal 41 of the receiver 2. The control of the combination circuit 8 takes place by the programmable control logic circuit 10 whose control signals are formed in the cycle of the clock generator 11 and are transmitted to the combination circuit 8 for the setting thereof. In the programmable control logic circuit 10, a permanently installed sequence program is stored by which in each case a predetermined linear combination, which is initiated by the period cycle, of the reception signals 5a, 5b is present at the output of the controllable and switchable combination circuit 8. The period to generated in the clock generator 11 and its division into the reception interval t1 and the search interval t2 as well as the number of rotations of the main direction are mutually coordinated and fixedly set such that the synchronization time is statistically as short as possible for as many received satellite signals as possible.

The settings of the sequence, which repeats cyclically according to a period t0 of the time duration t0, of the cycles for the division into a reception interval t1 of the time duration t1, into a search interval t2 of the time duration t2, and into the phase of the reception signal 5b, which is clocked repeating in steps in each case according to a step cycle interval ts during the search interval t2, can be set according to empirically found values and can vary within wide limits.

Favorable results can be achieved with to in the range of an update period over the satellite positions in the range of the order of 10 seconds and with a search interval in the range of the order of seconds and with the step cycle interval ts in the range of the order of tenths of seconds or hundredths of seconds for setting the consecutive phase steps within the search cycle t2.

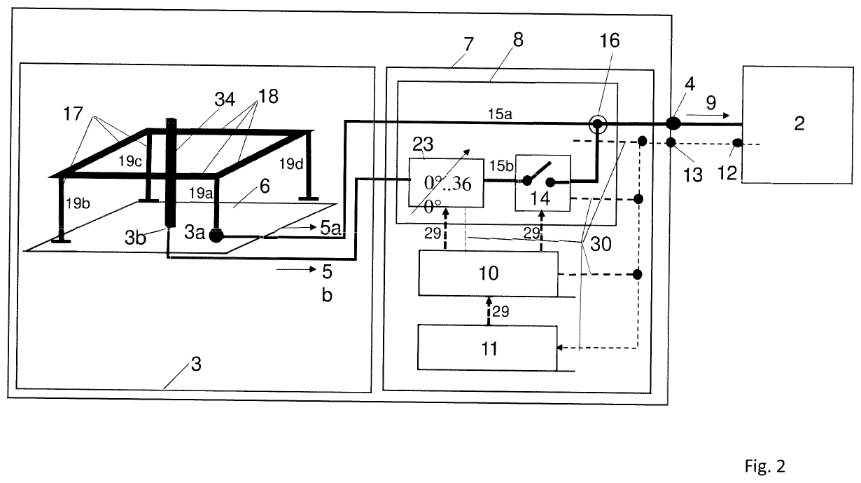

FIG. 2: Shows an antenna module according to the invention with a locating satellite receiver 2, as in FIG. 1, for a basic explanation of the mode of operation of the invention with reference to a multi-antenna system 3. Said multi-antenna system 3 comprises an N=1-th order ring line antenna 17 as the first individual antenna 3a with right-handed circular polarization, RHCP, and the main radiation direction towards the zenith with the current distribution of a running line wave in a single revolving direction, whose phase difference over one revolution is just 2π, with the first reception signal 5a, and comprises, as the second satellite reception antenna 3b, an N=0-th order vertical monopole antenna 15 for receiving the second reception signal 5b.

The first individual antenna 3a is regarded as a standard antenna and its reception signal 5a is permanently conducted via the summation element 16 to the antenna module terminal 4 and is present there during the reception interval t1.

This signal is superposed at a set phase angle of the phase rotation element 23 in the summation element 16 when the switch 14 is closed during the search interval t2.

Both antennas have an azimuthal omnidirectional diagram of the radiation density and an azimuthally linear distribution of the phase angle Ø=0-2π*N of an integer Nth order of the radiation over a corresponding azimuthal angle range of α=0-2π. The difference in the ordinal number N of the two antennas and the superposition of their reception signals 5a and 5b in the summation element 16 at a specific phase angle produces an azimuthal directional diagram at the antenna module terminal 4 with a maximum of the azimuthal radiation under a specific azimuthal main direction. In the case of a change in the phase in a stepwise clocked manner in the settable phase rotation element 23 between the phase angle range β=0 to β=2π and in the event of a superposition of the reception signal 5b shifted in phase, during the search interval t2, a radiation directional diagram with azimuthally between α=0 to α=2π—i.e. at least once—is present over a full rotation of the main direction of the radiation pivoted in steps. In the basic form, the azimuthal directional diagram describes a more or less pronounced cardioid with a significant increase in the radiation at the radiation maximum. Due to the increase in the radiation in the main direction, a significant increase in the locating probability of satellites with weakly incident satellite signals is given. As each period to elapses, due to the repeating rotation of the azimuthal directional diagram, the reception strength of the satellite signals in each case arriving from the azimuthal environment of the rotating main direction is increased, whereby these signals can be recognized and detected in the receiver. Thereafter, both the synchronization and the evaluation of the signals with regard to the locating data can then take place based on the lower signal strength during the reception intervals t1. Using the present invention, a larger number of satellites are thus detected and evaluated so that a greater locating accuracy is achieved as a result.

After synchronization of these satellite signals in the receiver, the evaluation of the satellite signals can take place during the reception interval t1 that is set for a longer period of time. The evaluation of more strongly incident satellite signals is practically unaffected by the rotating radiation diagram during the search interval t2 when avoiding a cardioid shape with a pronounced zero point in the directional diagram.

Even a slight concession to the maximum antenna gain in the azimuthal main direction resulting from the superposition of the two reception signals 5a, 5b produces a significantly smaller drop in the antenna gain in the opposite azimuthal direction. Due to the significantly smaller drop in the antenna gain, the probability of satellite signals that arrive in the opposite direction and that are already detected by the receiver being lost during the very short time of the passage in the opposite direction is thereby correspondingly small. To avoid a complete cancellation of the superposed reception signals 5a, 5b, the weighting of the two reception signals before their superposition in the summation element 16 or during the superposition in the settable radio frequency diplexer 38 is advantageous. This precise setting can take place particularly effectively by raising the magnitude of the reception signals 5a, 5b before the formation of their linear combination using low-noise amplifiers so that they can subsequently be correspondingly set in their size relative to one another using passive damping members. For this purpose, individual antennas 3a, 3b, 3c with amplifier circuits connected thereto, i.e. active antennas, can be advantageously used. The signal interferences possibly connected with the individual phase steps by a hard switchover can be largely avoided if the switchover is designed as a “soft” process. With phase rotation elements 23 whose phase is set by capacitor diodes, this can be easily realized by suitably controlling the diodes during the switchover.

Both the clock signals for the period to, the reception interval t1, the search interval t2 as well as for the steps for setting the phase rotation element 23 are transmitted via control lines 29 from the clock generator 11 to the programmable control logic circuit 10 by which the switch 14 and the phase rotation element 23 are set in a coordinated manner via further control lines 29 according to the sequence program. The DC power supply of said components takes place from the DCin terminal 13 via DC lines 30.

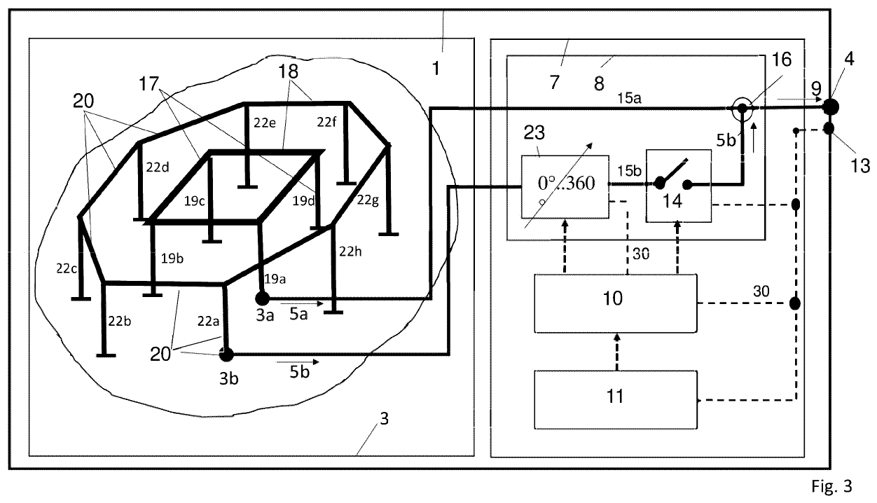

FIG. 3: The multi-antenna system 3 according to the invention comprises, as shown in FIG. 2, as the first individual antenna 3a, the N=1-th order ring line antenna 17 with right-handed circular polarization, RHCP, and the main radiation direction towards the zenith, comprising a ring line 18 arranged above the electrically conductive base surface 6 with the current distribution of a running line wave in a single revolving direction whose phase difference over one revolution is just 21, having four vertical radiators 19a, 19b, 19c, 19d connected to the ring line 18 and offset azimuthally by 90 degrees from one another, with tapping of the first reception signal 5a at a first of the vertical radiators 19a for forwarding to the reception signal combiner 7.

The multi-antenna system 3 comprises, as the second individual antenna 3b, a 2nd order ring line antenna 20 with right-handed circular polarization (RHCP) and the main radiation direction towards the zenith comprising an N=2- th order ring line 18 arranged above the electrically conductive base surface 6 with the current distribution of a running line wave in a single revolving direction whose phase difference over one revolution is just 4π, having 8 further vertical radiators 22a, . . . 22h connected to the ring line 18 and offset azimuthally by 45 degrees from one another, with tapping of the second reception signal 5a at a first of the vertical radiators 22a for forwarding to the reception signal combiner 7.

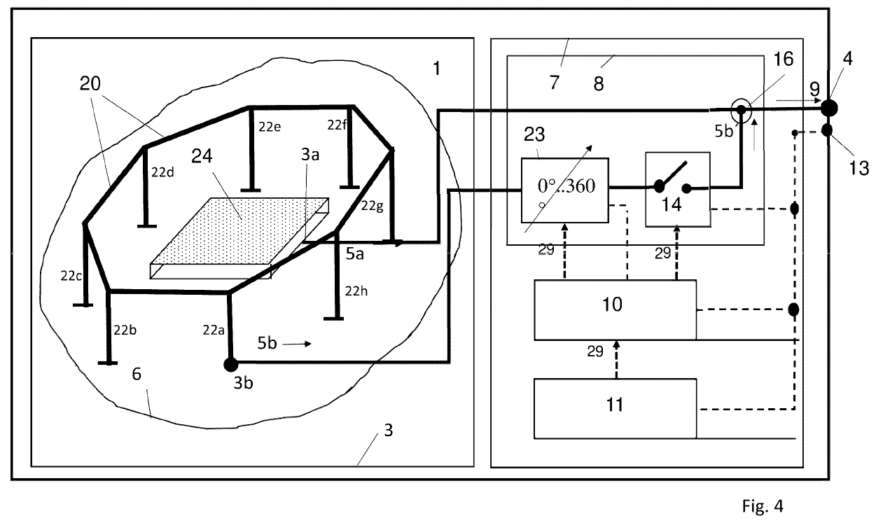

FIG. 4: Shows an antenna module 1 according to the invention in which, instead of the N=1-th order ring line antenna 17 in FIG. 3, as the first individual antenna 3a at the center of the second individual antenna 3b, an N=1-th order patch antenna 24 is present, with right-handed circular polarization, RHCP, and a distribution of the phase angle of the radiation of β=0-2π over the azimuthal solid angle α=0-2π and the main radiation direction towards the zenith, as the first reception signal 5a for forwarding to the reception signal combiner 7.

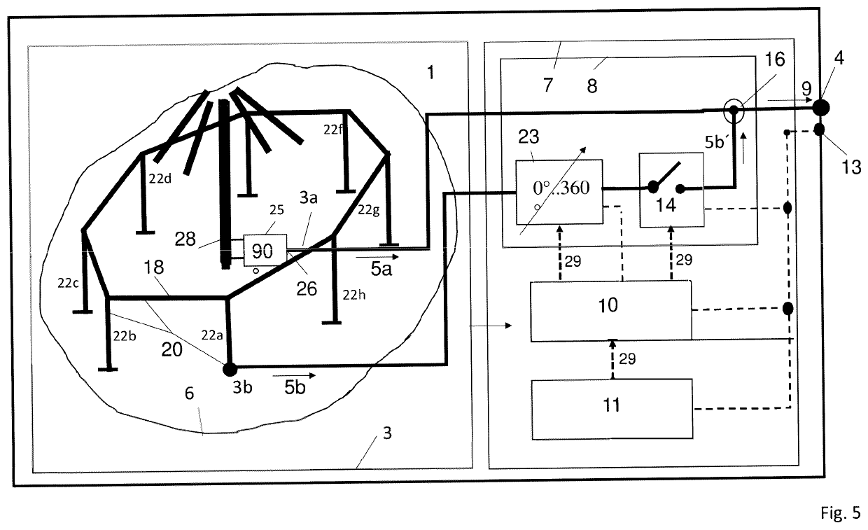

FIG. 5: Shows an antenna module 1 according to the invention in which, instead of the N=1-th order ring line antenna 17 in FIG. 3 as the first individual antenna 3a with the first reception signal 5a at the center of the second individual antenna 3b, a crossed dipole antenna 26 with right-handed circular polarization, RHCP, and the main radiation direction towards the zenith is present. Said crossed dipole antenna 26 consists of two dipoles 16a, 16b that are arranged vertically above the conductive base surface 6, that are crossed at 90 degrees, and that are substantially horizontally oriented. Both dipole halves are open downwardly in a V shape. Their dipole reception signals are combined via a 90 degree phase rotation element 25 to form the first separate reception signal 5a—for forwarding to the reception signal combiner 7.

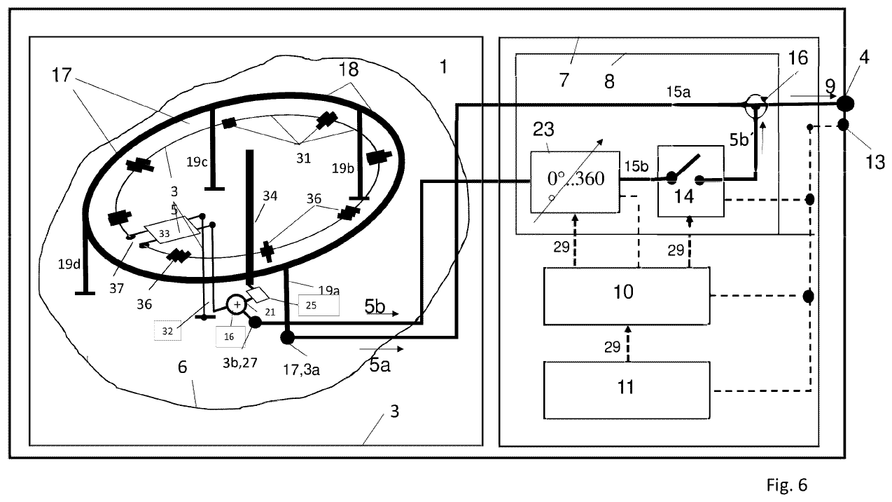

FIG. 6: The multi-antenna system 3 according to the invention shown comprises, as the first individual antenna 3a—as in FIGS. 1 and 2—, an N=1-th order ring line antenna 17 with right-handed circular polarization, RHCP, and the main radiation direction towards the zenith comprising a ring line 18 arranged above the electrically conductive base surface 6 with the current distribution of a running line wave in a single revolving direction whose phase difference over one revolution is just 2π, having four vertical radiators 22a, . . . 22c connected to the ring line and offset azimuthally by 90 degrees from one another, with tapping of the first reception signal 5a at a first of the vertical radiators 22a for forwarding the reception signals 5a to the reception signal combiner 7.

The second individual antenna 3b of the multi-antenna system 3 is formed as an N=0-th order combined loop monopole antenna 27 with circularly polarized, azimuthally in-phase radiation such that a loop antenna 35 comprising a conductor loop 31 with capacitors 36—concentric to the ring line antenna 17—is present. Said loop antenna 35 is formed from a conductor loop 31 arranged substantially in a horizontal plane in parallel above the conductive base surface 6 with a current distribution azimuthally uniform in phase and amplitude. The reception signal present at an interruption of the conductor loop is combined via a 90 degree phase rotation element 25 with the reception signal of an N=0-th order vertical antenna 34 arranged at the center of the conductor loop 31 to form the reception signal 5b in the summation element 16 so that the loop monopole antenna 27 is formed. The phase of the radiation of this antenna is thus likewise azimuthally independent, i.e. of N=0-th order, and is designed for right-handed circular polarization, RHCP. The main radiation direction results in the central region of the elevation for forwarding the reception signals 5b to the reception signal combiner 7.

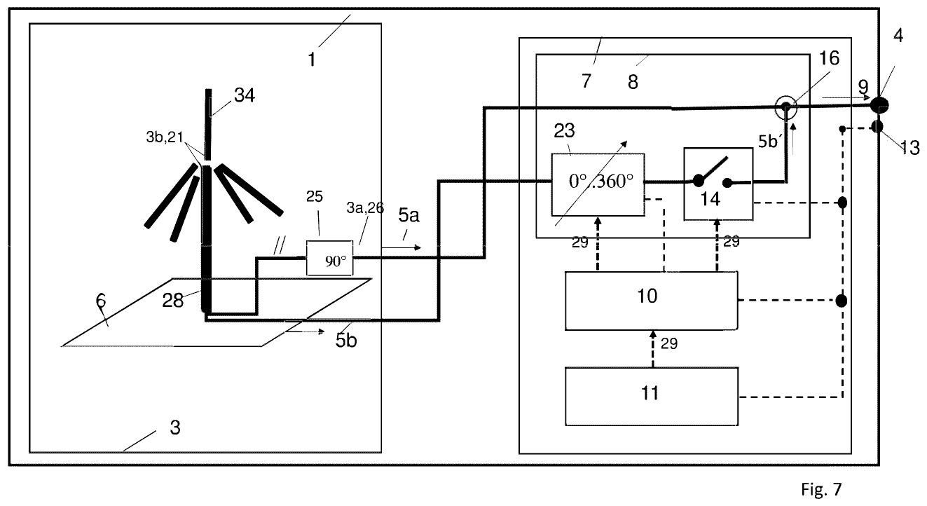

FIG. 7: The multi-antenna system 3 according to the invention shown comprises, as the N=1-th order first individual antenna 3a, a crossed dipole antenna 26 with right-handed circular polarization, RHCP, and the main radiation direction towards the zenith. Said crossed dipole antenna 26 consists—as in FIG. 5—of two dipoles that are located on a mast 28 arranged vertically above the conductive base surface 6, that are crossed by 90 degrees, that are substantially horizontally oriented and whose dipole halves open downwardly in a V shape and whose reception signals are combined via a 90 degree phase rotation element 25 to form the first separate reception signal 5 and for forwarding to the reception signal combiner 7.

The multi-antenna system 3 comprises, as an N=0-th order second individual antenna 3b, a vertical monopole antenna 34 located on the mast 28—for forwarding its reception signal 3b to the reception signal combiner 7.

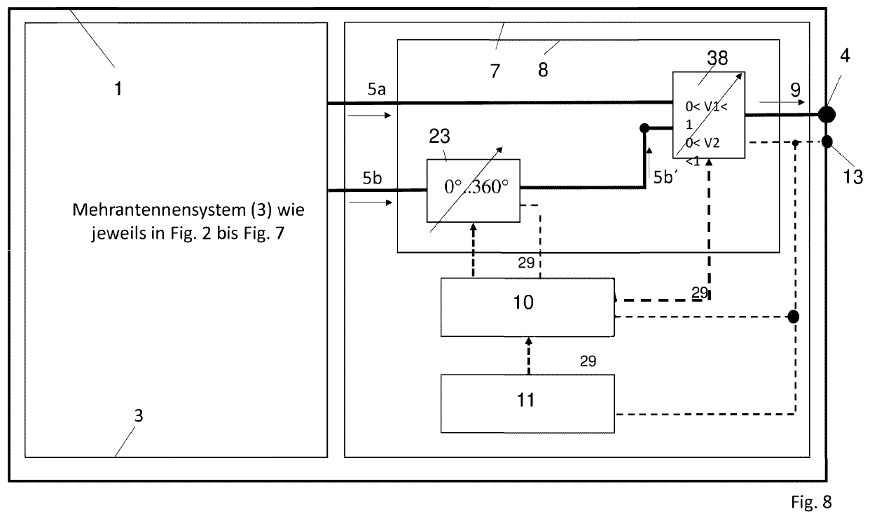

FIG. 8: Shows an antenna module 1 according to the invention having a respective multi-antenna system 3 as shown in FIGS. 2 to 7—but not described in detail here-comprising a respective reception signal combiner 7.

In the reception signal combiner 7, instead of the summation element 16 and the switch 14, a radio frequency diplexer 38 is, however, used which is set in the signal transmission V1, V2 by the control logic circuit 10 and in which the first reception signal 5a is assessed with the factor V1 and the second reception signal 5b′ occurring after the settable phase rotation element 23 is assessed with the factor V2 and both reception signals 5a, 5b′ are superposed to form the combined receiver signal 9.

In this respect, the control logic circuit 10 is programmed in an extended manner such that V1=1 is set and the setting of the signal transmission V2 of the radio frequency diplexer is set, starting with the setting V2=1, with values decreasing in V2 steps. In this respect, for each V2 step, the phase of the settable phase rotation element 23 has passed through the phase range, starting from 0° to 360°, in phase steps so that in each case a full azimuthal rotation of the main radiation direction is given and the radiation diagram with an azimuthal main direction with decreasing signal transmission values V2 in steps up to V2=0 is converted into an azimuthal omnidirectional diagram with the main direction towards the zenith.

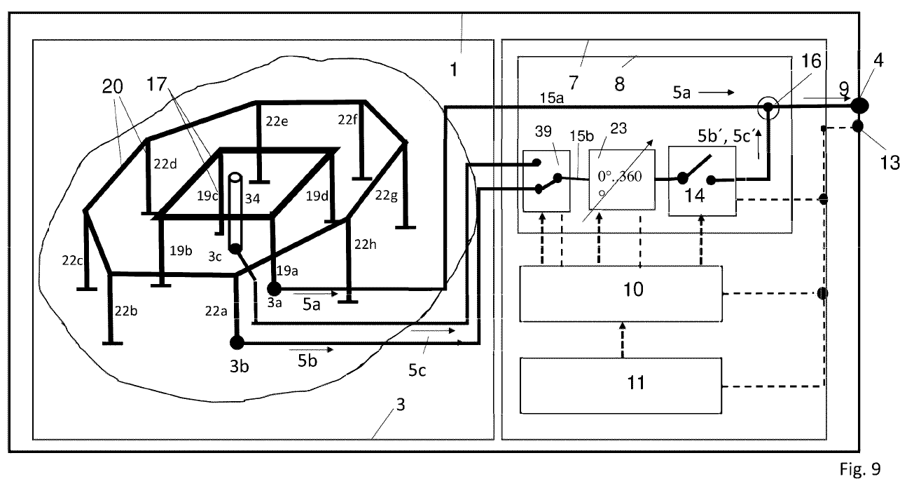

FIG. 9: Shows an antenna module 1 according to the invention as in FIG. 3 whose multi-antenna system 3, however, additionally has an N=0-th order vertical monopole antenna 34, which is concentrically arranged at the center of the N=1-th order ring line antenna 17, as the third individual antenna 3b for receiving the third reception signal 5c. Accordingly, the self-controlled signal combiner 7 in the Figure is extended as follows.

A changeover switch 39 controlled by the control logic circuit 10 is connected upstream of the settable phase rotation element 23, to which changeover switch 39 the second reception signal 5b and the third reception signal 5c are fed for an alternatively switched forwarding to the settable phase rotation element 23. The programming of the control logic circuit 10 is supplemented and the changeover switch 39 is controlled accordingly by the clock generator 11 in conjunction with the control logic circuit 10 such that the search interval t2 is divided into the search interval t2a and the search interval t2b that occur within a period t0 but do not necessarily have to follow one another in time. During these two search intervals, the switch 14 is closed and the second reception signal 5b and the third reception signal 5c are alternately forwarded to the settable phase rotation element 23 during the search interval t2a and during the search interval t2b. During the search interval t2a and the search interval t2b, the phase rotation element 23 is controlled in phase steps in each case over the range β=0 to β=2π and a different azimuthally rotating directional diagram with the main direction with a different vertical diagram is alternatingly provided in each case.

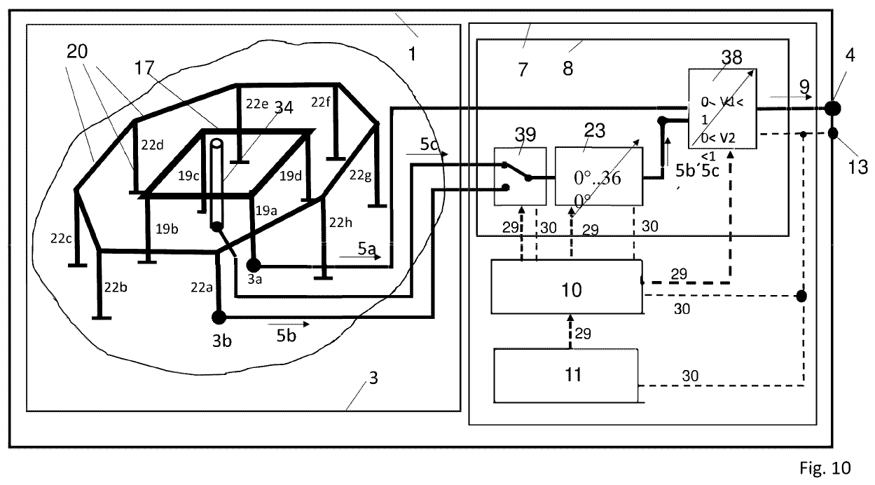

FIG. 10: Shows an antenna module 1 according to the invention as in FIG. 9; however, instead of the summation element 16 and the switch 14, a radio frequency diplexer 38 is used which is set in the signal transmission V1, V2 by the control logic circuit 10. In said radio frequency diplexer 38, the first reception signal 5a is assessed with the factor V1 and the second reception signal 5b′ occurring after the settable phase rotation element 23 during the search interval t2a is assessed with the factor V2a and the third reception signal 5c′ occurring during the search interval t2b is assessed with the factor V2b and in each case both reception signals 5a, 5b′ or 5a, 5c′ are alternatingly superposed to form the combined receiver signal 9.

The control logic circuit 10 is programmed in an extended manner such that V1=1 is set and the setting of the signal transmission V2a or V2b of the radio frequency diplexer is set, approximately starting with the setting V2a=V2b=1, with values decreasing in steps and, for each step, the phase of the settable phase rotation element 23 has passed through the phase range, starting from 0° to 360°, in phase steps at least once so that, for both positions of the changeover switch 39, in each case at least one full azimuthal rotation of the main radiation direction is given and the radiation diagram at the antenna module terminal 4 with the azimuthal main direction with decreasing signal transmission values V2a or V2b in steps up to V2a=0 or V2b=0 is converted, in each case also during the search intervals, into an azimuthal omnidirectional diagram with the main direction towards the zenith.

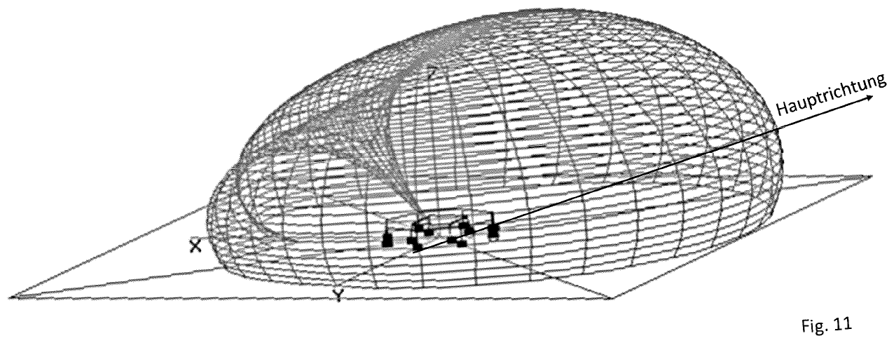

FIG. 11: Shows the spatial directional diagram of the reception signal with the main direction at the antenna module terminal 4 during a phase step with the combined individual antennas 3a and 3b shown in FIG. 3.

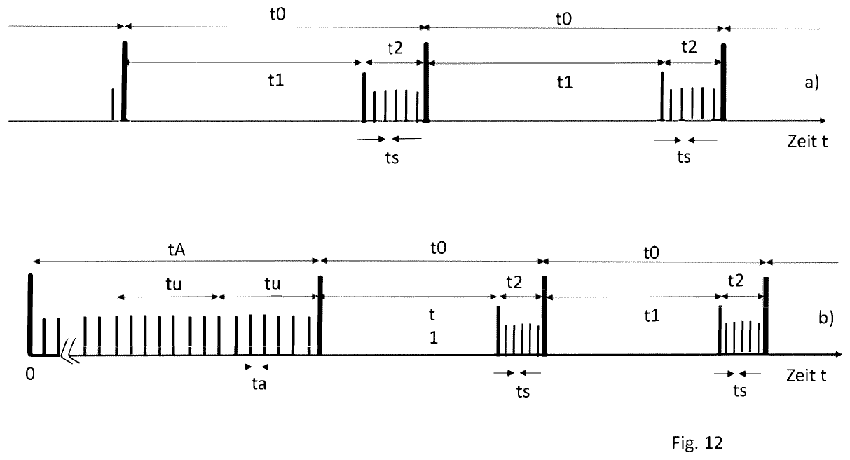

FIG. 12: a) Shows an example of the clock sequence generated in the clock generator 11 over the time with the period to with which all processes repeat cyclically and which is divided into the reception interval t1 that is longer in time and the search interval t2. During the reception interval t1, the standard antenna with the main radiation direction towards the zenith, designated here as the first individual antenna 3a, is switched through to the antenna module terminal 4. During this time, the locating in the receiver mainly takes place via the locating satellite signals detected by the receiver. According to the invention, during the search interval t2, the locating takes place with weakly incident locating satellite signals in that in each case a different phase is set at the settable phase rotation element 23 in time steps with the step cycle interval ts. Due to the combined signals from the first individual antenna 3a with a second individual antenna 3b or from the first individual antenna 3a with a third individual antenna 3c and due to the different order of the respective combined individual antennas, a horizontal directional diagram is given with each phase step, in each case with a radiation maximum in a different main direction for amplified reception of satellite signals at the antenna module terminal 4. When setting the phase rotation element 23 in steps between 0 and 360°, the main direction is rotated about the entire azimuth and the probability of locating further satellite signals is increased.

b) Shows an example of the clock sequence generated in the clock generator 11 over the time with the period to as in a), but with the peculiarity that, at the start (t=0) before the onset of the time sequences of the period to, a startup interval tA of the temporal length tA is inserted for a reliable recognition of as many satellite signals as possible. During the startup interval tA, the switch 14 is closed and the signal combined from the individual antennas 3a and 3b at the phase angle of the settable phase rotation element 23 is present at the antenna module terminal 4. In time steps ta, the phase of the settable phase rotation element 23 is set changed in each case such that the horizontal radiation diagram is rotated further with its main direction in the azimuth by a corresponding angular step. After the corresponding number of time steps ta has elapsed, a full rotation of the radiation directional diagram with its main direction is achieved at the rotation time tu. As a result, the satellite signals are in each case increased over the time of the passage of the radiation diagram maximum for easier signal recognition in the locating satellite receiver 2.

Favorable results are achieved, for example, with a startup interval tA in the range of the order of a few seconds with time steps ta in the range of hundredths of a second or tenths of a second and a rotation time tu in the range of the order of a second to set the consecutive phase steps within the time duration tA.

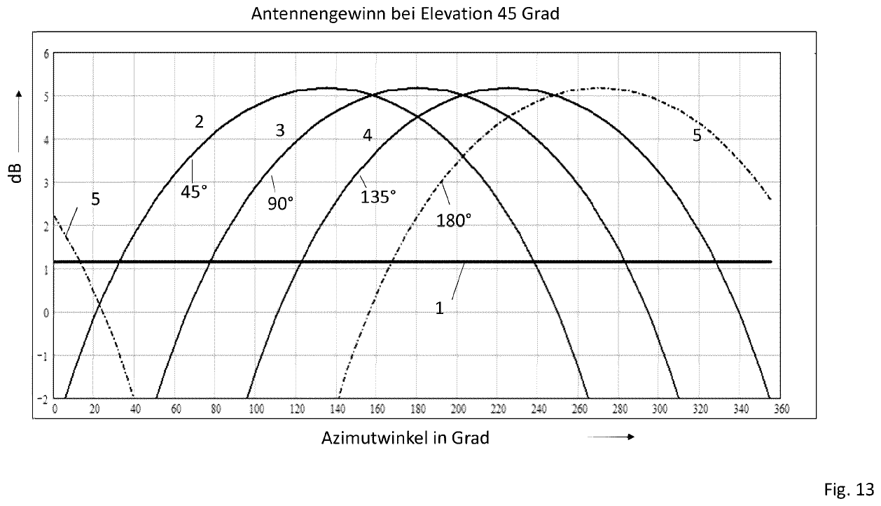

FIG. 13: The curves shown describe, by way of example, in each case the antenna gain of the antenna module in db over the entire azimuth at an elevation of the signal incidence below 45° with the combined ring antennas 17, 20 discussed in FIG. 11 and shown in FIG. 3.

Curve 1 describes the constant antenna gain of the inner ring antenna over the azimuth as the first individual antenna 3a with the order N=1 during the reception interval t1.

The curves 2-5 each describe the antenna gain achieved during the search intervals t2 with different settings of the settable phase rotation element 23 in 45° phase steps, shown for the phase steps 45° to 180° with the correspondingly shifting main direction in the azimuth. The maxima in the azimuthal main direction of these curves provide, in each case after each period t0 over the time duration of a phase step ts, an increased antenna gain of up to 4 db for each azimuthal angle sector compared to the standard antenna. This significantly increases the probability of locating weak satellite signals that may otherwise remain undetected with the standard antenna.

The particular advantage of an antenna module 1 of the invention is, on the one hand, the economic efficiency of the realization by means of the exemplarily disclosed or similar multi-antenna systems 3 whose individual antennas 3a, . . . 3c can partly consist of sheet metal antennas, rod antennas or patch antennas that can be arranged concentrically to one another with a small space requirement. On the other hand, the self-controlled signal combiner 7 with its components consisting substantially of analog modules and its clock generator 11 consisting of electronic modules and its programmable control logic circuit 10 can be inexpensively designed for series production. The components of the clock generator 11 and the programmable control logic circuit 10 are shown separately here for the sake of clarity. Both components can be advantageously combined to form an integrated digital and programmable processor that controls the settable phase rotation elements 23, the switch 14 and the settable radio frequency diplexer 38.

In one embodiment, the provided sequence program is loaded in the programmable processor for setting the antenna module 1 for operation with a locating satellite receiver 2, for example, via the antenna module terminal 4.

### REFERENCE NUMERAL LIST

Antenna module 1
Locating satellite receiver 2
Multi-antenna system 3
Individual antenna 3a, 3b, 3c . . .
Antenna module terminal 4
Separate reception signals 5a, 5b, 5c
Conductive base surface 6
Self-controlled reception signal combiner 7
Controllable, switchable combination circuit 8
Combined receiver signal 9
Programmable control logic circuit 10
Clock generator 11
DCout terminal 12
DCin terminal 13
Switch 14
Signal path 15a, 15b
Summation element 16
1st order ring line antenna 17
Ring line 18
Vertical radiators 19a, 19b, 19b, 19c
2nd order ring line antenna 20
Monopole connection point 21
Vertical radiators 22a, . . . 22h
Settable phase rotation element 23
Patch antenna 24
90 degree phase rotation element 25
Crossed dipole antenna 26
0th order loop monopole antenna 27
Mast 28
Control line 29
DC lines 30
Conductor loop 31
Two-wire line 32
Unbalancing element 33
Vertical monopole antenna 34
Loop antenna 35
Capacitor 36
Conductor loop connection point 37
Settable radio frequency diplexer 38
Changeover switch 39
Radio frequency line 40
Radio frequency terminal 41
Power distribution setting V1=0-1, V2=0-1
Phase angle Ø=0-2π*N of the antenna radiation vs. azimuth
Integer order N
Azimuthal angle α=0-21,
Period t0 of the time duration t0
Reception interval t1 of the time duration t1
Search interval t2 of the time duration t2
Phase angle range of the phase actuator element β=0 to β=2π
Step cycle interval ts
Startup interval tA of the time duration tA
Step lengths ta
Rotation time tu
Phase angle of the radiation Ø
Azimuthal angle α

1-16. (canceled)

17. An antenna module for mobile reception of locating satellite signals, said antenna module comprising:
an electrically conductive base surface on which a multi-antenna system is formed from a plurality of mutually concentrically arranged reception antennas for receiving respective separate locating satellite signals, in each case with an azimuthal omnidirectional diagram of the radiation density and an azimuthally linear distribution of the phase angle Ø=0-2π*N of an integer Nth order of the radiation over a corresponding azimuthal angle range of α=0-21,
wherein the multi-antenna system comprises:
an N=1-th order circularly polarized first reception antenna for receiving locating satellite signals with the main radiation direction towards the zenith, and
at least one further antenna whose order N differs from the order of the first reception antenna by the integer 1 in each case, and
a reception signal combiner which is controlled according to a permanently installed sequence program, to which the reception signals of the individual antennas are fed at the input side and which is connected to an antenna module terminal at the output side, wherein the control is such that,
a) during a reception interval of the time duration t1, the reception signal of the first reception antenna is switched through to the antenna module terminal,
b) a reception signal of one of the further antennas that is clocked in steps in its phase and is shifted—at least once—between the phase angle range β=0 to β=2π is additively superposed on the reception signal of the first reception antenna during at least one search interval of the time duration t2 following the reception interval t1 so that, during the search interval, a radiation directional diagram with azimuthally between α=0 and α=2π—i.e. at least once—is given over a full rotation of the main direction pivoted in steps, and
c) the steps a) and b) are cyclically repeated with a period t0.

18. The antenna module according to claim 17,
further comprising the following features:
the reception signal combiner comprises a combination circuit, which is switched in a controlled manner and to which the reception signals of the reception antennas are fed, for the controlled selection of the first reception signal during the reception interval as a receiver signal and for the additive superposition, formed during the search interval, of said first reception signal with the reception signal of one of the further reception antennas, which is rotated in phase in a controlled stepwise manner, as a linearly combined receiver signal in each case at the antenna module terminal, and/or
the reception signal combiner comprises a programmed control logic circuit for setting various switching states of a switchable combination circuit and an independently operating clock generator for generating a cyclically repeating clock sequence, in each case consecutively divided into cycles with a time interval t1 and cycles with a time interval t2 for the clocked control of the programmed control logic circuit.

19. The antenna module according to claim 18,
further comprising the following features:
the combination circuit switched in a controlled manner comprises:
a signal path of the reception signal of the first reception antenna with a summation element for superposing this reception signal with the reception signals from the signal path of the further reception antenna to form a receiver signal at an antenna module terminal, and/or
a signal path of the further reception signal of one of the further reception antennas with a phase rotation element, which is controlled in phase steps between β=0 to β=2π by the control logic circuit during the search interval t2, and a switch, which is open by control during the reception interval t1 and closed during the search interval t2, for the controlled forwarding of the further reception signal rotated in phase to the summation element in order to form the receiver signal by superposition with the first reception signal, and/or
control lines between the programmed control logic circuit and a controlled phase rotation element for the clocked setting of the phase rotation element during the search interval t2 and the switch for controlling its opening during the reception interval t1 and its closing during the search interval t2.

20. The antenna module according to claim 18,
further comprising at least one of the following features:
in the combination circuit, a summation element is present in the signal path of the fed first reception signal, in which summation element, by the switch controlled by the control logic circuit, the reception signals occurring after the switches are superposed during the search interval t2,
a phase rotation element controlled in phase steps by the control logic circuit and, in series therewith, a switch controlled by the control logic circuit are inserted in the signal path of the second reception signal for the controlled switching through of the reception signal to the summation element,
the control logic circuit is programmed such that the switch is opened during the reception interval t1 and closed during the search interval t2 so that, alternately, in each case during the reception interval t1, the effect of a right-handed circularly polarized, RHCP, antenna with the main radiation direction facing towards the zenith is given at the antenna module terminal and, during the search interval t2, by the superposition with the second reception signal that is changed in steps in the phase in the settable phase rotation element, after the superposition in the summation element, an antenna with azimuthally bundled radiation with the main radiation direction azimuthally pivoted in steps is given at the antenna module terminal.

21. The antenna module according to claim 17,
further comprising the following features:
the multi-antenna system comprises, as the first reception antenna, an N=1-th order ring line antenna with right-handed circular polarization, RHCP, and the main radiation direction towards the zenith, comprising a ring line arranged above the electrically conductive base surface with the current distribution of a running line wave in a single revolving direction whose phase difference over one revolution is just 2π, having four vertical radiators connected to the ring line and offset azimuthally by 90 degrees from one another, with tapping of the first reception signal at a first of the vertical radiators, and
the multi-antenna system comprises, as the second reception antenna, an N=0-th order vertical monopole antenna, which is arranged concentrically to the N=1-th order ring line antenna, for receiving the second reception signal.

22. The antenna module according to claim 17,
further comprising the following features:
the multi-antenna system comprises, as the first reception antenna, an N=1-th order ring line antenna with right-handed circular polarization, RHCP, and the main radiation direction towards the zenith, comprising a ring line arranged above the electrically conductive base surface with the current distribution of a running line wave in a single revolving direction whose phase difference over one revolution is just 2π, having four vertical radiators connected to the ring line and offset azimuthally by 90 degrees from one another, with tapping of the separate first reception signal at a first of the vertical radiators, and
the multi-antenna system comprises, as the second reception antenna, a 2nd order ring line antenna with right-handed circular polarization, RHCP, and the main radiation direction towards the zenith, comprising an N=2-th order ring line arranged above the electrically conductive base surface with the current distribution of a running line wave in a single revolving direction whose phase difference over one revolution is just 4π, having eight further vertical radiators connected to the ring line and offset azimuthally by 45 degrees from one another, with tapping of the second reception signal at a first of the vertical radiators.

23. The antenna module according to claim 22,
wherein, instead of the N=1-th order ring line antenna as the first reception antenna at the center of the second reception antenna, an N=1-th order patch antenna is present, with right-handed circular polarization, RHCP, and a distribution of the phase angle of the radiation of β=0-2π over the azimuthal solid angle α=0-2π and the main radiation direction towards the zenith, as the first reception signal.

24. The antenna module according to claim 22,
wherein, instead of the N=1-th order ring line antenna as the first reception antenna with the first reception signal at the center of the second reception antenna, a crossed dipole antenna with right-handed circular polarization, RHCP, and the main radiation direction towards the zenith is present, said crossed dipole antenna consisting of two dipoles that are located on a mast arranged vertically above the conductive base surface, that are crossed by 90 degrees, that are substantially horizontally oriented and whose dipole halves open downwardly in a V shape and whose reception signals are combined via a 90 degree phase rotation element to form a first separate reception signal.

25. The antenna module according to claim 17,
further comprising the following features:
the multi-antenna system comprises, as the first reception antenna, an N=1-th order ring line antenna with right-handed circular polarization, RHCP, and the main radiation direction towards the zenith, comprising a ring line arranged above the electrically conductive base surface with the current distribution of a running line wave in a single revolving direction whose phase difference over one revolution is just 2π, having four vertical radiators connected to the ring line and offset azimuthally by 90 degrees from one another, with tapping of the first reception signal at a first of the vertical radiators, and/or
the second reception antenna of the multi-antenna system is formed as an N=0-th order combined loop monopole antenna with circularly polarized, azimuthally in-phase radiation such that a loop antenna comprising a conductor loop with capacitors—concentric to the ring line antenna—is present that consists of a conductor loop arranged substantially in a horizontal plane in parallel above the conductive base surface with a current distribution azimuthally uniform in phase and amplitude and whose reception signal present at an interruption of the conductor loop is combined via a 90 degree phase rotation element with the reception signal of an N=0-th order vertical antenna arranged at the center of the conductor loop to form the reception signal with likewise an N=0-th order for right-handed circular polarization, RHCP, and the main radiation direction in the central region of the elevation in a summation element.

26. The antenna module according to claim 17,
further comprising the following features:
the multi-antenna system comprises, as an N=1-th order first reception antenna, a crossed dipole antenna with right-handed circular polarization, RHCP, and the main radiation direction towards the zenith, consisting of two dipoles that are located on a mast arranged vertically above the conductive base surface, that are crossed by 90 degrees, that are substantially horizontally oriented and whose dipole halves open downwardly in a V shape and whose reception signals are combined via a 90 degree phase rotation element to form the first separate reception signal, and/or
the multi-antenna system comprises, as an N=0-th order second reception antenna, a vertical monopole antenna located on the mast.

27. The antenna module according to claim 19,
wherein, instead of the summation element and the switch, a radio frequency diplexer is used which is set in the signal transmission V1, V2 by the control logic circuit and in which the first reception signal is assessed with the factor V1 and the second reception signal occurring after the settable phase rotation element is assessed with the factor V2 and both reception signals are superposed to form the combined receiver signal, and the control logic circuit is programmed in an extended manner such that V1=1 is set and the setting of the signal transmission V2 of the radio frequency diplexer is also set, starting with the setting V2=1, with values decreasing in V2 steps and, for each V2 step, the phase of the settable phase rotation element has passed through the phase range, starting from 0° to 360°, in phase steps so that in each case a full azimuthal rotation of the main radiation direction is given and the radiation diagram with an azimuthal main direction with decreasing signal transmission values V2 in steps up to V2=0 is converted into an azimuthal omnidirectional diagram with the main direction towards the zenith.

28. The antenna module according to claim 17,
wherein
the multi-antenna system additionally has, as a third reception antenna, an N=0-th order vertical monopole antenna, which is concentrically arranged at the center of the N=1-th order ring line antenna (17), for receiving a third reception signal, and/or
wherein the self-controlled signal combiner has the following features:
a changeover switch controlled by the control logic circuit is connected upstream of the settable phase rotation element, to which changeover switch the second reception signal and the third reception signal are fed for an alternatively switched forwarding to the settable phase rotation element, and/or
the programming of the control logic circuit is supplemented and the changeover switch is controlled accordingly by the control logic circuit such that the search interval t2 is divided into the search interval t2a, during which the second reception signal is switched through to the phase rotation element, and into the search interval t2b, during which the third reception signal is switched through to the phase rotation element, and the phase rotation element is controlled in phase steps in each case over the range β=0 to β=2π during the search interval t2a and the search interval t2b and the switch is closed during the two search intervals t2a and t2b.

29. The antenna module according to claim 19,
wherein,
instead of the summation element and the switch, a radio frequency diplexer is used which is set in the signal transmission V1, V2 by the control logic circuit and in which the first reception signal is assessed with the factor V1 and the second reception signal occurring after the settable phase rotation element during the search interval t2a is assessed with the factor V2a and the third reception signal occurring during the search interval t2b is assessed with the factor V2b and in each case both reception signals are superposed to form the combined receiver signal, and/or
the control logic circuit is programmed in an extended manner such that V1=1 is set and the setting of the signal transmission V2a or V2b of the radio frequency diplexer is set, approximately starting with the setting V2a=V2b=1, with values decreasing in steps and, for each step, the phase of the settable phase rotation element has passed through the phase range, starting from 0° to 360°, in phase steps at least once so that, for both positions of the changeover switch, in each case at least one full azimuthal rotation of the main radiation direction is given and the radiation diagram with the azimuthal main direction with decreasing signal transmission values V2a or V2b in steps up to V2a=0 or V2b=0 is converted in each case into an azimuthal omnidirectional diagram with the main direction towards the zenith.

30. The antenna module according to claim 17,
wherein, in the self-controlled signal combiner, a sequence program is stored that is designed such that, with its start, before the onset of the time sequences of the period t0, a startup interval tA of the temporal length tA takes place during which the switch is closed and, in consecutive temporal step lengths ta, the settable phase rotation element is set accordingly changed in each case so that the horizontal radiation diagram is rotated further with its main direction in the azimuth by one angular step so that the radiation directional diagram is rotated with its main direction once in each case during the rotation time tu and least z=time during the startup interval tA—over a full horizontal rotation.

31. The antenna module according to claim 17,
wherein, in each case instead of an N=1-th order ring line antenna arranged at the center, an N=1-th order patch antenna is present, with right-handed circular polarization, RHCP, and a distribution of the phase angle of the radiation of β=0-2 over the azimuthal solid angle α=0-27 and the main radiation direction towards the zenith, and a concentrically arranged N=0-th order vertical monopole antenna is arranged centrally above the patch antenna, and/or wherein the control logic circuit is programmed in an extended manner such that V1=1 and V2=0 are set so that an azimuthal omnidirectional diagram is set and such that, at the start of the search interval t2, the phase of the settable phase rotation element passes through the phase range, starting from 0° to 360°, in phase steps after the start of the search interval t2 so that in each case a full azimuthal rotation of the main radiation direction is given and, during this phase rotation, the directional diagram is converted into the radiation diagram with the azimuthal main direction by signal transmission values V2 continuously increasing in small steps up to a maximum value so that in each case a full azimuthal rotation of the main radiation direction is given, and/or wherein
the setting of the maximum value of V2 is maintained for a few rotations, and/or wherein, in order to end the cycle, the setting of the signal transmission V2 of the radio frequency diplexer is set, starting with its maximum value, in continuously decreasing values, and/or wherein the radiation diagram with the azimuthal main direction is converted back into the radiation diagram with an azimuthal omnidirectional diagram with the main direction towards the zenith in the time during which the phase of the settable phase rotation element continued to pass through the phase range, starting from 0° to 360°, in phase steps, from the maximum value of V2 up to the value V2=0.

32. The antenna module according to claim 17, wherein the period to, the time duration t1 and the time duration t2 are empirically determined values.
